(19) United States
(12) Patent Application Publication
(10) Pub. No.: US 2002/0184078 A1
(43) Pub. Date: Dec. 5, 2002

(54) Priority-based vehicle allocation methods

(76) Inventor: Robert Uyeki, Torrance, CA (US)

Correspondence Address: David J. Meyer, Manatt, Phelps & Phillips, LLP, 11355 West Olympic Boulevard, Los Angeles, CA, 90064, US

(21) Appl. No.: 09/875,385

(22) Filed: Jun. 5, 2001

(51) Int. Cl. G06F 17/60

(52) U.S. Cl. 705/10

(57) ABSTRACT

The invention provides priority-based allocation methods for use in allocating a vehicle from a fleet of vehicles. The methods provide that a vehicle that is low on fuel, battery charge, or mileage will be given a higher priority for allocation than a vehicle with relatively higher vehicle parameters. Methods include using the vehicle parameter values to directly allocate the vehicles, or indirectly allocate the vehicles using the values to group the vehicles before allocation. Additional indirect methods are provided whereby the vehicle parameter values are used to derive a corresponding numerical value to be used in an algorithm-based allocation method or converted into a percentage for a tier-based allocation method.

### BACKGROUND OF THE INVENTION

1. Field of the Invention

The present invention relates to a vehicle allocation method usable in allocating a vehicle from a fleet of vehicles.

2. Description of the Related Art

The typical vehicle rental experience is well known. A customer in need of flexible transportation selects the type of vehicle that will suit the user's purpose or economic means. An attendant then randomly chooses a vehicle from a pool of available vehicles that best fit the user's requirements. Typically, the vehicle that is selected will have a full fuel tank at the beginning of the rental period. The tank is full because either the previous customer filled the tank before returning it or because a rental car attendant filled the tank. A customer will fill a tank before returning the vehicle in order to avoid a penalty. The penalty typically utilized is charging the customer an unreasonably high price per gallon to fill the vehicle by the rental car attendants. Not only does this tactic take advantage of the customer, but leads to an inefficient use of rental car attendants who must take the time to refill the tank even if it is already ¾ full.

Another drawback to this method of allocating vehicles with full fuel tanks is the anxiousness and frustration that it often creates for customers. For example, in order to avoid the penalty, a customer must search for a gas station in a location with which they are likely not familiar and, more often than not, the customer is in a hurry to make an appointment such as catching an airline flight.

In order to deal with the some of the shortcomings of this method, some rental car facilities provide the customer the option of purchasing the entire tank of gas prior to their use of the vehicle. The price charged is usually a reasonable rate, however, no refund is provided to the customer when the vehicle is returned with unused fuel. Although the rental car facility reaps a windfall for that gas that was purchased but not used, which is to the detriment of the customer, it still must employ an attendant to fill the tank for the next user. An allocation method which, by its very operation, insured that a majority of the vehicles in a fleet had sufficient fuel levels for operation and a majority of the refueling was done by the users, rather than the fleet operator, would be beneficial.

Another problem that exists in the typical vehicle allocation process is that it does not consider the vehicle battery charge. This oversight can lead to vehicles with “dead” batteries since an idle vehicle's battery will eventually lose its charge. This can cause delays when a selected vehicle fails to start. To prevent the delay, rental facilities may make an effort to keep the batteries charged using portable charging devices that keep the vehicle batteries within a usable range. It would be more efficient if the battery charge was known beforehand so that the vehicle could be allocated before the battery is run down. The allocation of a vehicle with a low battery charge would be beneficial as the customer would aid in the battery recharging process simply by driving the vehicle, as a result, a majority of the vehicles in the fleet would consist of vehicles with sufficiently charged batteries.

Vehicle mileage is also an important consideration that is not readily considered in the typical vehicle allocation process. The random allocation of vehicles leads to the inefficient use of vehicles when some vehicles accumulate high mileage, while other cars go unused. A method of uniformly allocating vehicles for use would prevent the premature wear and tear of vehicles and conserve automotive maintenance resources.

In related art, vehicle-sharing systems have been developed to address the need for a more flexible approach to public transportation and vehicle rentals. The allocation of such vehicles is based, at least in part, on the travel information received from users when vehicles are requested. User information aids in the efficient usage of vehicles and user convenience can be optimized, for example, to maximize vehicle availability and minimize vehicle downtime by selecting the appropriate vehicle for the intended trip.

A method of allocation of electric vehicles in a vehicle-sharing system is disclosed in U.S. patent application Ser. No. 09/348,515 and is hereby incorporated by reference. In the allocation method disclosed, information entered by the user is communicated to a central facility along with information from a vehicle subsystem. The user information generally comprises either expected duration of use or the expected distance of the intended trip. The vehicle information generally consists of how much usable energy is available in the battery for use, odometer information and vehicle location. Based on the user information and vehicle information, the central facility selects a vehicle from among the fleet to allocate to the user. The invention relates primarily to the use of electric vehicles.

In U.S. Pat. No. 5,812,070 a shared vehicle rental system is disclosed which allocates vehicles based on the user's previous travel information. For example, if a user past usage has been found to be relatively short, and the available motor vehicles are electric, then the shared vehicle rental system allocates a motor vehicle whose battery is not fully charged. Likewise, a fully charged vehicle will be allocated to a user whose past usage indicates that the user requires a vehicle capable of a relatively long duration of use. Simply allocating vehicles based on a user's previous travel information would not accommodate an efficient allocation of vehicles since vehicles that do not meet the user's derived needs are not used. Again, the invention is primarily concerned with allocation of electric vehicles. The disclosure, however, does mention that the method could be compatible with vehicles using internal combustion engines. Thus, a method of insuring that a majority of the vehicles in a fleet were in the preferred ranges (high fuel and battery charge levels, and consistent mileage) would be beneficial to operators of vehicle-sharing systems as well.

There is also a need to efficiently allocate vehicles in the context of companies that rely upon a fleet of vehicles to conduct their daily business activities. For example, utility companies, mail delivery businesses, and various other sales and service industries commonly rely on a fleet of vehicles to service customers and conduct their business. A strategy of vehicle allocation that insures that a majority of the vehicles in the fleet have sufficient fuel levels, battery charge levels, and similar mileage would be advantageous.

Thus, what is needed is a method for prioritizing the allocation of vehicles such that vehicle parameters are considered to provide for an effective allocation strategy, whereby the end result of the allocation is that a majority of the vehicles in the fleet have desirable vehicle parameters with limited attendant participation.

### SUMMARY OF THE INVENTION

The present invention is directed to a priority-based allocation method that satisfies the need to more efficiently allocate a vehicle from a fleet.

To achieve the above objective, methods of prioritizing the allocation of a vehicle from a fleet of vehicles are provided. The methods are based on the premise that an efficient allocation of vehicles would create a situation where a majority of the vehicles in the fleet are sufficiently fueled and charged, while also insuring relatively equal usage of the vehicles within a fleet.

The priority-based allocation methods are facilitated through the use of ranking the vehicles using various vehicle parameters or associating a number value for various vehicle parameters. The vehicle parameters considered include the vehicle's fuel level, battery charge, and mileage information. The values are used in various methods of allocation. The methods include using the vehicle parameter values to directly allocate vehicles, or indirectly allocate the vehicles using the values to group the vehicles before allocation. Additional indirect methods are provided whereby the vehicle parameter values are used to derive a corresponding numerical value to be used in an algorithm-based allocation method or converted into a percentage for a tier-based allocation method.

Each method disclosed provides that a vehicle that is low on fuel, battery charge, or mileage will be given a higher priority for allocation than a vehicle with relatively higher parameters. This priority-based allocation creates the advantageous situation whereby a majority of the vehicles in a fleet have the desirable high fuel and battery levels, and consistent mileage levels. An additional benefit is that a large part of the effort to maintain the vehicles in such a manner is shifted to the vehicle user rather than the fleet operator, thus significantly diminishing the number of attendants required to keep the fleet in similar fashion.

Particular embodiments of the invention include using the various vehicle parameters to directly allocate the vehicle with the lowest value or values relative to the other vehicles in the fleet. For example, a vehicle with the lowest level of fuel in a given fleet of vehicles will be allocated first.

In a preferred embodiment of the invention vehicle parameter values are used in an algorithm-based method of vehicle allocation. The values are inversely related to the corresponding vehicle parameter such that the arithmetic sum of the values indicates the most appropriate vehicle to be allocated at any given time. For example, a vehicle that is low on fuel, battery charge, and mileage would have relatively large arithmetic sum. A large arithmetic sum indicates that the vehicle needs to be allocated. In contrast, vehicles with a full fuel tank, fully charged battery, and high mileage would have a relatively small arithmetic sum and, therefore, have a low allocation priority.

In other embodiments, the vehicle parameter values are used to group the vehicles with similar values and then allocate from groups with the lowest values or sets of values before vehicles in groups with higher relative values or sets of values. For example, vehicles with similar mileage and battery charge will be grouped together and vehicles within the group that includes the vehicles with the lowest mileage and battery charge will be allocated before vehicles in a group with correspondingly higher values.

In an additional embodiment of the invention, a tier-based method is used to prioritize the allocation of vehicles. Here the vehicle parameter values are used to place a vehicle into a specific tier. Vehicles are then allocated based on their tier level. For example vehicles with the lowest battery charge relative to the other vehicles in the fleet are given the highest priority for allocation regardless of the other fuel and mileage parameters. Likewise, a tier with the lowest allocation priority would include vehicles with relatively a high level of fuel, battery charge, and mileage.

### BRIEF DESCRIPTION OF THE DRAWINGS

These and other features, aspects, and advantages of the present invention will become better understood with regard to the following description, appended claims, and accompanying drawings where:

FIG. 1 is a flow chart depicting a method of prioritizing the allocation of vehicles from a fleet using an algorithm-based method.

FIG. 2 is a flow chart depicting a method of prioritizing the allocation of vehicles from a fleet using a tier-based method.

### DESCRIPTION

The present invention relates to methods for prioritizing the allocation of vehicles from a fleet.

As indicated in the Background section above, the efficient allocation of vehicles within a fleet requires a priority-based allocation strategy. The methods disclosed provide that a vehicle that is low on fuel, battery charge, or mileage will be given a higher priority for allocation than a vehicle with relatively higher parameters. This priority-based allocation creates the advantageous situation whereby a majority of the vehicles in a fleet have the desirable high fuel and battery levels, and consistent mileage.

An additional benefit is that a majority of the effort to maintain the vehicles in such a manner is now borne by the vehicle user, rather than the fleet operator, thus significantly diminishing the number of attendants typically required to keep a fleet in similar fashion. The vehicle user aids in the maintenance of the fleet status by refueling the vehicles and recharging the battery during its use. A vehicle that is low on fuel when allocated is more likely to be returned with more fuel, while simple driving of the vehicle recharges the battery. Thus, the user has provided the services normally attributed to the fleet operator.

As can be appreciated from the above, it is contemplated that the individual vehicle parameters can be used to form an effective priority-based allocation method alone such that the vehicle within the fleet with the lowest individual vehicle parameter is allocated first. It is also contemplated that the vehicle parameter values can be used to group vehicle with similar values and then allocate from groups with the lowest values or sets of values before vehicles in groups with higher relative values or sets of values. For example, vehicles with similar mileage and battery charge will be grouped together and vehicles within the group that includes the vehicles with the lowest mileage and battery charge will be allocated before vehicles in a group with correspondingly higher values. However, reference will now be made in detail to the preferred embodiments of the invention, examples of which are illustrated in the accompanying drawings.

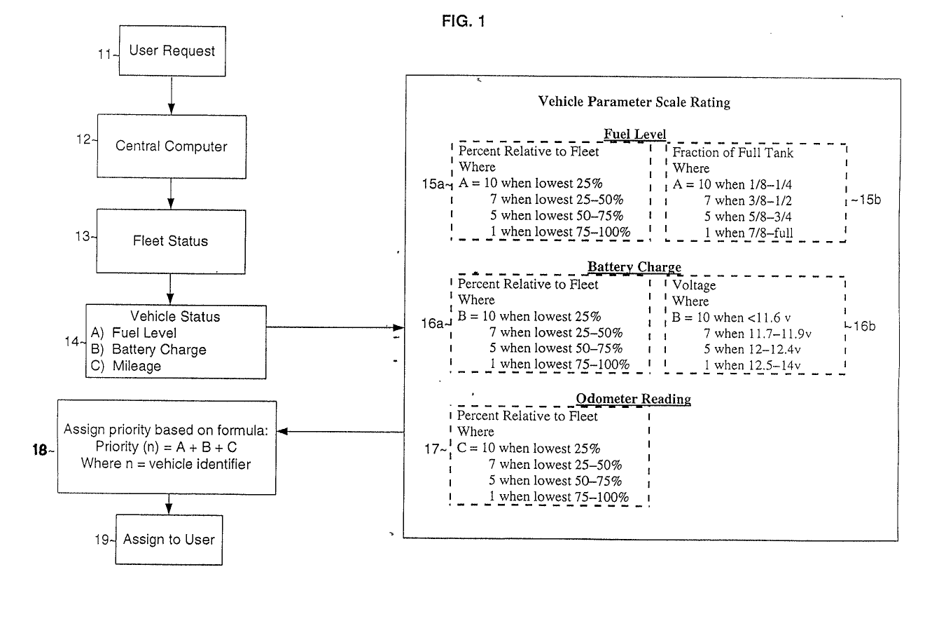

With reference to FIG. 1, a flow chart depicting a method of prioritizing the allocation of vehicles from a fleet using an algorithm-based method is shown. As shown in step 11, a user requests a vehicle for use. The user may also request a specific type of vehicle such that the method would be applied within the group comprising the vehicle type. The user request is communicated to a central computer 12. The central computer 12 determines information regarding the available vehicles in the fleet 13. In addition, the central computer 12 receives vehicle parameter information transmitted from the vehicle sensors relating to the vehicle's current fuel level, battery charge and mileage status 14. To assign a given vehicle priority for allocation the computer converts the vehicle parameter information into a numerical value and uses it in equation 18 as shown here, n=A+B+C, where:

n=vehicle identifier,

A=fuel level 15a or 15b;

B=battery charge 16a or 16b; and

C=mileage 17,

such that the vehicle with the largest arithmetic sum is allocated to the user 19 by the central computer 12. Additionally, in the embodiment of FIG. 1, equation 18 can be used with just two, and any two, of the available variables A, B, and C. The step of converting the vehicle parameter information into a percentage for purposes of prioritizing the vehicles used in steps 15a, 16a, and 17 is discussed below with respect to the tier-based methodology.

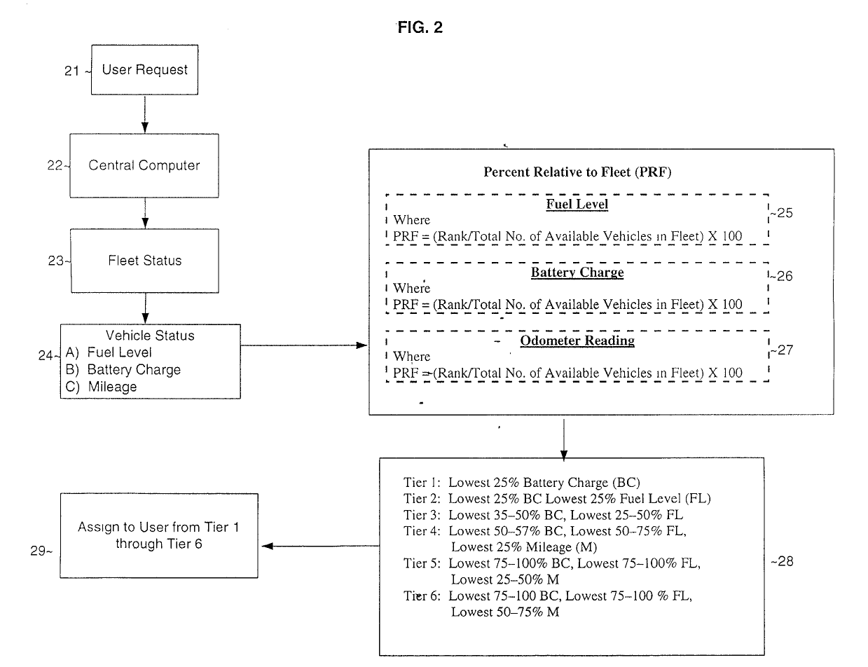

With reference now to FIG. 2, a flow chart depicting a method for prioritizing the allocation of vehicles using a tier-based method is shown. The first steps are the same as in the algorithmic method where the user requests a vehicle 21 and the central computer 22 checks the vehicle fleet status 23. The step of prioritizing the vehicles considers the vehicle parameters relative to the vehicles in the fleet. This is accomplished by determining the fuel, battery, and mileage levels of each vehicle in the fleet 24. This may be done through an attendant verifying the parameters manually or, preferably, through the use of vehicle sensing devices that constantly monitor the vehicles and relay the information to the central computer. The central computer then ranks the vehicles from lowest to highest with respect to each of the vehicle parameters. A simple mathematical computation known in the art is used to convert the rank into a value which represents the vehicle as a percentage of the vehicle fleet 25, 26, 27.

With the percentages determined, the central computer than places each vehicle in the respective tiers 28, and assigns vehicles to the user from tier 1 to tier 6 in numerical order 29.

The methods described above offer an efficient and cost-effective way of allocating a vehicle from a fleet. The methods insure that a majority of the vehicles in the fleet have sufficient fuel and battery levels, and consistent mileage. Furthermore, it is to be emphasized that this beneficial end result is brought about with limited participation on the part of vehicle attendants. Instead, the methods take advantage of the vehicle users as a resource in maintaining the vehicles at proper levels.

Although the present invention has been described in detail with reference to certain preferred versions thereof, other embodiments that are within the scope of the claimed inventions are possible. For example, in the method for the priority-based allocation of vehicles using a numerical value inversely related to each vehicle parameter such that the vehicle with the highest arithmetic sum is allocated, it is understood that a method of using a numerical value directly related to each vehicle parameter such that the vehicle with the lowest arithmetic sum would be allocated is equivalent. It should also be understood that the numerical values used to derive the arithmetic sum are arbitrary in absolute terms and are provided only as an example. The numerical values gain their meaning through their values relative to the vehicle parameters, such that any numbers could be used that have the same correlation. Finally, the applicable methods disclosed herein, although preferably applying to automobiles with internal combustion engines, are contemplated to apply to any vehicle. Therefore, the spirit and scope of the appended claims should not be limited to the description of the embodiments disclosed herein.

1. A method for the priority-based allocation of vehicles comprising the step of allocating a vehicle with the lowest level of fuel relative to vehicles in a fleet.

2. A method for the priority-based allocation of vehicles comprising the step of allocating a vehicle with the lowest battery charge relative to vehicles in a fleet.

3. A method for the priority-based allocation of vehicles comprising the step of allocating a vehicle with the lowest mileage relative to vehicles in a fleet.

4. A method for the priority-based allocation of vehicles, the method comprising the steps of deriving the arithmetic sum of:
a) a numerical value inversely related to the vehicle fuel level, where the numerical value is equal to:
i) 10 when the vehicle's fuel level is in the lowest 25% relative to the vehicles in the fleet;
ii) 7 when the vehicle's fuel level is in the lowest 25-50% relative to the vehicles in the fleet;
iii) 5 when the vehicle's fuel level is in the lowest 50-75% relative to the vehicles in the fleet;
iv) 1 when the vehicle's fuel level is in the lowest 75-100% relative to the vehicles in the fleet; and
b) a numerical value inversely related to the vehicle battery charge, where the numerical value is equal to:
i) 10 when the vehicle's battery charge is in the lowest 25% relative to the vehicles in the fleet;
ii) 9 when the vehicle's battery charge is in the lowest 25-50% relative to the vehicles in the fleet;
iii) 7 when the vehicle's battery charge is in the lowest 50-75% relative to the vehicles in the fleet;
iv) 1 when the vehicle's battery charge is in the lowest 75-100% relative to the vehicles in the fleet,
whereby the vehicle with the highest arithmetic sum is allocated.

5. A method for the priority-based allocation of vehicles, the method comprising the steps of deriving the arithmetic sum of:
a) a numerical value inversely related to the vehicle fuel level, where the numerical value is equal to
i) 10 when the vehicle's fuel level is in the lowest 25% relative to the vehicles in the fleet;
ii) 7 when the vehicle's fuel level is in the lowest 25-50% relative to the vehicles in the fleet;
iii) 5 when the vehicle's fuel level is in the lowest 50-75% relative to the vehicles in the fleet;
iv) 1 when the vehicle's fuel level is in the lowest 75-100% relative to the vehicles in the fleet; and
b) a numerical value inversely related to the vehicle mileage, where the numerical value is equal to:
i) 10 when the vehicle's mileage is in the lowest 25% relative to the vehicles in the fleet;
ii) 7 when the vehicle's mileage is in the lowest 25-50% relative to the vehicles in the fleet;
iii) 5 when the vehicle's mileage is in the lowest 50-75% relative to the vehicles in the fleet;
iv) 1 when the vehicle's mileage is in the lowest 75-100% relative to the vehicles in the fleet,
whereby the vehicle with the highest arithmetic sum is allocated.

6. A method for the priority-based allocation of vehicles, the method comprising the steps of deriving the arithmetic sum of:
a) a numerical value inversely related to the vehicle battery charge, where the numerical value is equal to:
i) 10 when the vehicle's battery charge is in the lowest 25% relative to the vehicles in the fleet;
ii) 9 when the vehicle's battery charge is in the lowest 25-50% relative to the vehicles in the fleet;
iii) 7 when the vehicle's battery charge is in the lowest 50-75% relative to the vehicles in the fleet;
iv) 1 when the vehicle's battery charge is in the lowest 75-100% relative to the vehicles in the fleet; and
b) a numerical value inversely related to the vehicle mileage, where the numerical value is equal to:
i) 10 when the vehicle's mileage is in the lowest 25% relative to the vehicles in the fleet;
ii) 7 when the vehicle's mileage is in the lowest 25-50% relative to the vehicles in the fleet;
iii) 5 when the vehicle's mileage is in the lowest 50-75% relative to the vehicles in the fleet;
iv) 1 when the vehicle's mileage is in the lowest 75-100% relative to the vehicles in the fleet,
whereby the vehicle with the highest arithmetic sum is allocated.

7. The method for the priority-based allocation of vehicles of claim 6 wherein the step of deriving the arithmetic sum further comprises:
a numerical value inversely related to the vehicle fuel level, where the numerical value is equal to:
a) 10 when the vehicle's fuel level is in the lowest 25% relative to the vehicles in the fleet;
b) 7 when the vehicle's fuel level is in the lowest 25-50% relative to the vehicles in the fleet;
c) 5 when the vehicle's fuel level is in the lowest 50-75% relative to the vehicles in the fleet; and
d) 1 when the vehicle's fuel level is in the lowest 75-100% relative to the vehicles in the fleet.

8. A method for the priority-based allocation of vehicles, the method comprising the steps of deriving the arithmetic sum of:
a) a numerical value inversely related to the vehicle fuel level, where the numerical value is equal to:
i) 10 when the vehicle's fuel level is ⅛-¼ full;
ii) 7 when the vehicle's fuel level is ⅜-½ full;
iii) 5 when the vehicle's fuel level is ⅝-¾ full;
iv) 1 when the vehicle's fuel level is ⅞ full-full; and
b) a numerical value inversely related to the vehicle battery charge, where the numerical value is equal to:
i) 10 when the vehicle's battery voltage is less than 11.7 volts;
ii) 9 when the vehicle's battery voltage is 11.7-11.9 volts;
iii) 7 when the vehicle's battery voltage is 12-12.4 volts;
iv) 1 when the vehicle's battery voltage is 12.5-14 volts; and
c) a numerical value inversely related to the vehicle mileage, where the numerical value is equal to:
i) 10 when the vehicle's mileage is in the lowest 25% relative to the vehicles in the fleet;
ii) 7 when the vehicle's mileage is in the lowest 25-50% relative to the vehicles in the fleet;
iii) 5 when the vehicle's mileage is in the lowest 50-75% relative to the vehicles in the fleet; and
iv) 1 when the vehicle's mileage is in the lowest 75-100% relative to the vehicles in the fleet.

9. A method for the priority-based allocation of vehicles, the method comprising the step of:
grouping vehicles within a fleet with similar fuel levels,
whereby a group comprising vehicles with the lowest levels relative to other groups of vehicles in the fleet are allocated first.

10. The method for the priority-based allocation of vehicles of claim 9 wherein the step of grouping vehicles within a fleet, the group further comprising:
vehicles with similar battery charge.

11. The method for the priority-based allocation of vehicles of claim 9 wherein the step of grouping vehicles within a fleet, the group further comprising:
vehicles with similar mileage.

12. The method for the priority-based allocation of vehicles of claim 10 wherein the step of grouping vehicles within a fleet, the group further comprising:
vehicles with similar mileage.

13. A method for the priority-based allocation of vehicles, the method comprising the step of:
grouping vehicles within a fleet with similar battery charge,
whereby a group comprising vehicles with the lowest levels relative to other groups of vehicles in the fleet are allocated first.

14. A method for the priority-based allocation of vehicles, the method comprising the step of:
grouping vehicles within a fleet with similar mileage,
whereby a group comprising vehicles with the lowest levels relative to other groups of vehicles in the fleet are allocated first.

15. The method for the priority-based allocation of vehicles of claim 14 wherein the step of grouping vehicles within a fleet, the group further comprising:
vehicles with similar battery charge.

16. A method for the priority-based allocation of vehicles, the method comprising the step of:
grouping vehicles with similar levels of fuel, battery charge, and mileage in tiers where vehicles in the first tiers have low levels of fuel, battery charge, and mileage relative to the vehicles in later tiers,
whereby vehicles are allocated from the first tiers before the vehicles in the later tiers.

17. A method for the priority-based allocation of vehicles, the method comprising the steps of:
a) placing vehicles with lowest 25% of battery charge relative to vehicles in a fleet in tier 1;
b) placing vehicles with lowest 25% of battery charge and lowest 25% of fuel relative to vehicles in a fleet in tier 2;
c) placing vehicles with lowest 25-50% of battery charge and lowest 25-50% of fuel level relative to vehicles in a fleet in tier 3;
d) placing vehicles with lowest 50-75% of battery charge and lowest 50-75% of fuel level and lowest 25% of mileage relative to vehicles in a fleet in tier 4;
e) placing vehicles with lowest 75-100% of battery charge and lowest 75-100% of fuel level and lowest 25-50% of mileage relative to vehicles in a fleet in tier 5; and
f) placing vehicles with lowest 75-100% of battery charge and lowest 75-100% of fuel level and lowest 50-75% of mileage relative to vehicles in a fleet in tier 6,
whereby vehicles are allocated tiers 1 through 6.
